(19) United States
(12) Patent Application Publication
(10) Pub. No.: US 2008/0139174 A1
(43) Pub. Date: Jun. 12, 2008

(54) Method, apparatus and computer program enabling the counting of devices in an authorized domain

(75) Inventor: Jukka Antero Alve, Vantaa (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/999,489

(22) Filed: Dec. 4, 2007

Related U.S. Application Data
(60) Provisional application No. 60/872,904, filed on Dec. 4, 2006.

(51) Int. Cl. H04M 1/66; H04M 1/00

(52) U.S. Cl. 455/411; 455/550.1

(57) ABSTRACT

The exemplary embodiments include a method that involves determining a logical device count for individual ones of a plurality of devices in an authorized domain; calculating a sum of the logical device counts; and comparing the sum with a maximum allowable number of devices for the authorized domain, where the logical device count for a device may be equal to one, less than one, or greater than one. The logical device count is a value greater than one when a particular device is includes multiple consumption points, where a value of the logical device count equals a number of consumption points for the particular device, and the logical device count is a value less than one when a particular consumption point includes multiple devices, such as when a plurality of speakers are used to express content.

### CLAIM OF PRIORITY FROM COPENDING PROVISIONAL PATENT APPLICATION

This patent application claims priority under 35 U.S.C. §119(e) from Provisional Patent Application No. 60/872,904, filed Dec. 4, 2006, the disclosure of which is incorporated by reference herein in its entirety.

### FIELD OF THE INVENTION

The exemplary embodiments of this invention relate generally to Digital Rights Management (DRM). More particularly, the exemplary embodiments of this invention relate to device counting as a method of limiting the size of an Authorized Domain in Domain Based DRM.

### BACKGROUND OF THE INVENTION

DRM refers to number of processes for restricting the free use and transfer of digital content. DRM is used in various types of media, including video files, music and audio files, and others. The implementation of Domain Based DRM requires its own system and protocols.

Digital Video Broadcasting (DVB) refers to standards being developed by an industry-led consortium of broadcasters, manufacturers, network operators, software developers, regulatory bodies for the global delivery of digital television and data services. DVB is currently developing a Content Protection and Copy Management standard (CPCM) standard for persistent protection for commercial content in consumer digital products and home networks. Reference can be made, for example, to “Digital Video Broadcasting (DVB) Content Protection and Copy Management”, DVB Document A094, November 2005, and to “Digital Video Broadcasting (DVB) Content Protection and Copy Management”, DVB Document A094, Rev. 1, July 2007, incorporated herein by reference in their entirety. These documents describe the CPCM reference model.

DVB Technical Module work group on Content Protection Technology (DVB-TM-CPT) has proposed the concept of an Authorized Domain. Associated with an Authorized Domain is data, such as films, music, software and the like, and a number of devices capable of using the data. Devices associated with the domain would be able to share the data associated with the domain and protected by the DVB CPCM system, but devices not associated with the domain would not be able to share the data.

As defined in the DVB Document A094 an Authorized Domain is a distinguishable set of DVB CPCM compliant devices, which are owned, rented or otherwise controlled by members of a single household. A household is considered to be the social unit consisting of all individuals who live together, as occupants of the same domicile. This makes no assumptions about the physical locations of the devices owned, rented or otherwise controlled by the members of the household.

Reference may be had, for example, to Part 7 of DVB Document A094, Rev. 1, July 2007, CPCM Authorised Domain Management.

As defined in the DVB Document A094 Content is the data that is to be protected by the CPCM system. This is generally audio-visual content plus optional accompanying data, such as subtitles, images/graphics, animations, web pages, text, games, software (both source code and object code), scripts, or any other information which is intended to be delivered to and consumed by a user.

As defined in the DVB Document A094 Consumption is a tangible rendition of Content, or a device output containing a transformation or signal that is intended to inhibit any usage other than the immediate conversion of the Content to sound and vision.

As is defined in the DVB Document A094 a Consumption Point is an abstract CPCM functional entity where consumption is performed.

As is defined in DVB Document A094 a Domain Controller is a global logical function providing overall control of the ADSE functions of an Authorised Domain, either residing in a single CPCM Instance (though moveable), or distributed among a defined maximum number of CPCM Instances, where a CPCM Instance is defined as a Conformant implementation of any CPCM functionality.

As is defined in DVB Document A094 an Authorised Domain Size and Extent (ADSE) refers to Mechanism(s) to prevent an AD growing beyond a “reasonable” size.

As is defined in DVB Document A094 a Countable Instance of CPCM Functionality (CICF) is a CPCM Instance that is capable of Consumption or Export and that has the appropriate bit set within its CPCM Instance Certificate to indicate that it shall be counted in the context of ADSE.

As is also defined in DVB Document A094 a CPCM Device is a device that hosts one or more CPCM Instances.

### SUMMARY

In accordance with a first aspect of this invention a method is provided that comprises determining a logical device count for at least one device in an authorized domain; calculating a sum of the logical device counts; and comparing the sum with a maximum allowable number of devices for the authorized domain, where the logical device count for a device may be equal to one, less than one, or greater than one.

In accordance with another aspect of this invention an apparatus includes a receiver configurable to receive broadcast content, the receiver associated with a logical device of an authorized domain; and memory configurable to store a logical device count having a value equal to one, less than one, or greater than one.

In accordance with another aspect of this invention there is provided a computer readable medium storing program instructions, execution of which result in operations that include determining a logical device count for individual ones of a plurality of devices in an authorized domain; calculating a sum of the logical device counts; and comparing the sum with a maximum allowable number of devices for the authorized domain, where the logical device count for a device may be equal to one, less than one, or greater than one.

In accordance with a further aspect of this invention an apparatus includes a receiver configurable to receive content and coupled with a logical device of an authorized domain; and a storage unit configurable to store a logical device count having a value equal to one, less than one, or greater than one.

### BRIEF DESCRIPTION OF THE DRAWINGS

These and other advantages and features of the invention, together with the organization and manner of operation thereof, will become apparent from the following detailed description when taken in conjunction with the accompanying drawings, wherein like elements have like numerals throughout the several drawings described below.

FIG. 1 is a diagram of an authorized domain with N media devices.

FIG. 2 is a diagram of a first embodiment of the invention.

FIG. 3 is a diagram of a second embodiment of the invention.

FIG. 4 shows a perspective view of a mobile phone for which the exemplary embodiments of this invention can be used.

FIG. 5 shows a schematic representation of circuitry of the mobile phone in FIG. 4.

FIG. 6 is a logic flow diagram that depicts the execution of a method, as well as the execution of a computer program, in accordance with the exemplary embodiments of this invention.

### DETAILED DESCRIPTION

A device count is herewith considered to be associated with a method of limiting the size of an Authorized Domain. A problem with providing a simple device count is whether all devices should be counted with a similar weight, regardless of what type of device they are.

In one embodiment the number of Consumption Points that can share content bound to the Authorized Domain should be limited. Accordingly, there is a need to define a procedure, and corresponding apparatus, that can be used to limit the number of consumption points in an Authorized Domain.

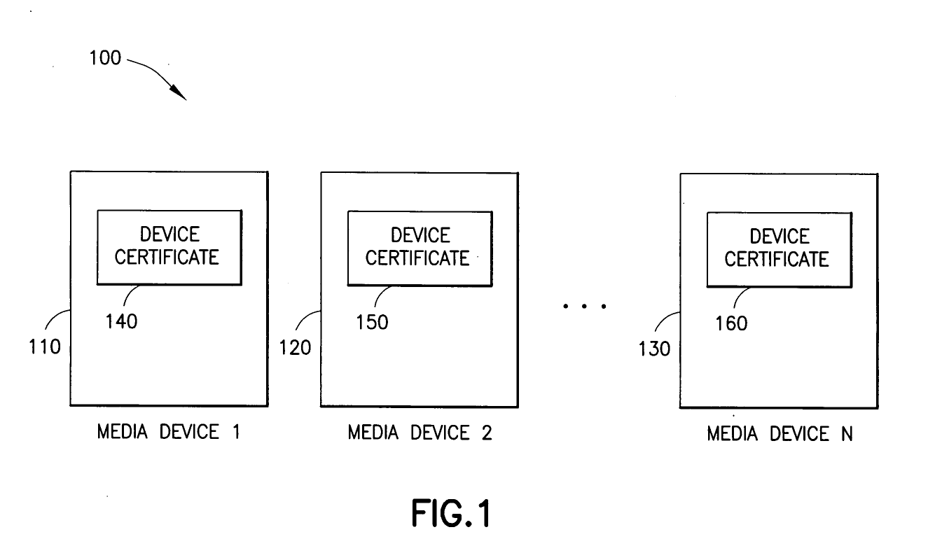

Exemplary embodiments of this invention include the addition of a new field in a device certificate held by a device capable of consumption. FIG. 1 shows an authorized domain 100 with maximum allowable number of devices M. The domain includes media device 1 (110), media device 2 (120) and media device N (130). Within each media device there is a device certificate (140,150,160). It may be assumed that each media device (100, 110, 120) includes some type of digital data storage medium for storing the device certificate.

Various embodiments of the exemplary embodiments of this invention provide a new field to indicate the logical device count of a physical device. This logical device count is used to limit the size of an Authorized Domain. The logical device count can be a number greater than one when there are multiple Consumption Points associated with the device. The logical device count may be a fractional number when a single Consumption Point includes multiple physical devices, more than one of which are used for a full rendering of the content. For example, consider a video monitor and speaker. If these two components are integrated into one physical device, the logical device count is one. But if they are separate devices, the logical device count of each of the monitor and speaker is one half. In this manner one may reach a consistent result as if these two components (devices) were integrated together when counting the number of devices in the Authorized Domain. Similarly, consider a multi-channel speaker system, where each speaker is separately connected to a network. If the total device count allowed in the Authorized Domain is 8, and a user desires to use an 8-channel speaker system with each speaker separately connected to the network, the logical device count of each of the speakers should be one eighth rather than one. In this case the user can enjoy the content without all of the allowable device count (eight in this example) being consumed by the speakers alone.

That is, the logical device count field may indicate a value of one, less than one or greater than one, depending on the nature of the device.

In one exemplary embodiment of this invention, the fractional numbers are represented by using a fixed-point (e.g., 8-bit) binary representation, for example:

00000001= 1/16
00000010=⅛
00000100=¼
00001000=½
00010000=1
00100000=2
01000000=4
10000000=8

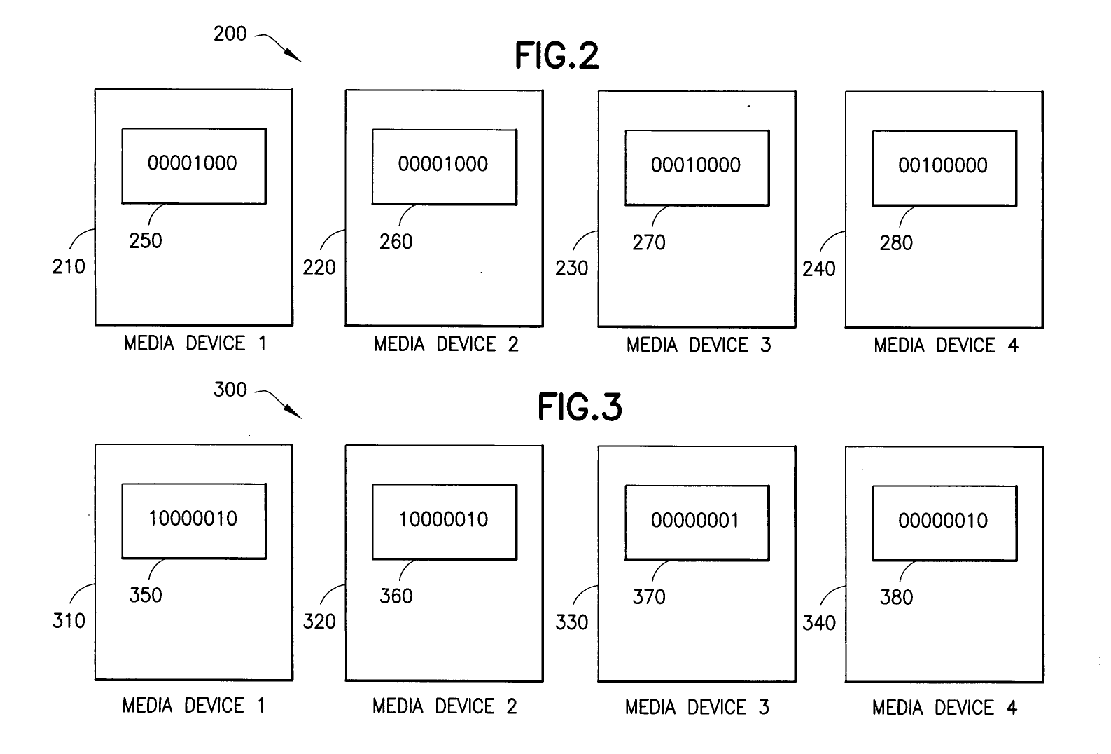

It is understood that the values above are intended as examples. Thus, with this fixed point binary representation one may also encode 00000011=⅛+ 1/16= 3/16, and so on. FIG. 2 shows a diagram of this embodiment. In FIG. 2, media device 1 (210) and media device 2 (220) each have a logical device count of “00001000” (250,260), which equals to ½ as indicated above. Media device 3 (230) has a logical device count of “00010000” (270), which equals to 1. Media device 4 (240) has a logical device count of “00100000” (280), which equals to 2. This embodiment has the advantage of simplicity in implementation; however, it may be noted that not all the fractional numbers can be easily represented. For example, ⅓ would be such a number that is not able to be precisely represent by this embodiment.

In another embodiment of this invention, at least one bit of the device count is taken as having special meaning. In the description below, the highest or most significant bit (MSB) is used as an example of this bit that has special meaning; however it is understood that any bit can be used for this purpose. In the example below, when the MSB is 0, the device count is an integer value with value greater than or equal to one.

When the MSB is 1, the device count is interpreted as a fractional number with the numerator as 1 and the denominator represented by the binary value of the remainder of the bits. For example:

10000010=½
10000011=⅓
10000101=⅕
10001000=⅛
00000001=1 (or equivalently 10000001)
00000010=2
00000011=3
00001000=8

FIG. 3 shows a diagram of this embodiment. In FIG. 3, media device 1 (310) and media device 2 (320) each have a logical device count of “10000010” (350,360), which equals to ½ as indicated above. Media device 3 (330) has a logical device count of “00000001” (370), which equals to 1. Media device 4 (340) has a logical device count of “00000010” (380), which equals to 2. This indicates that media device 4 has 2 Consumption Points.

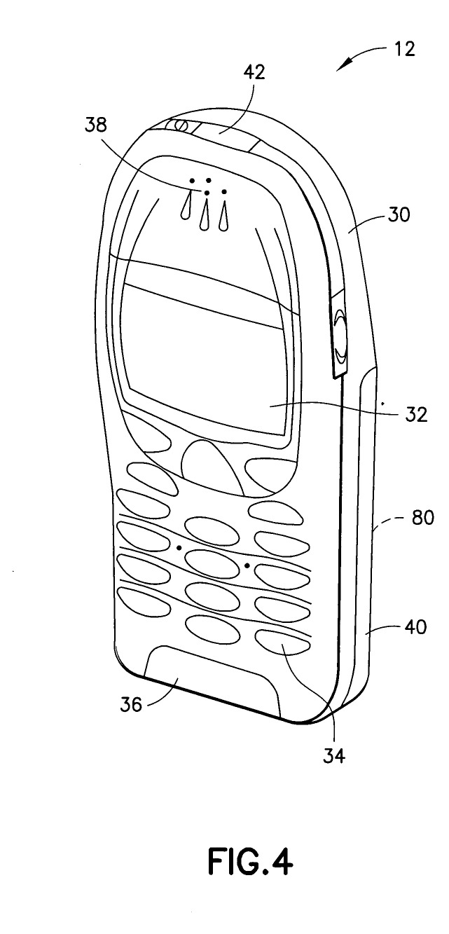

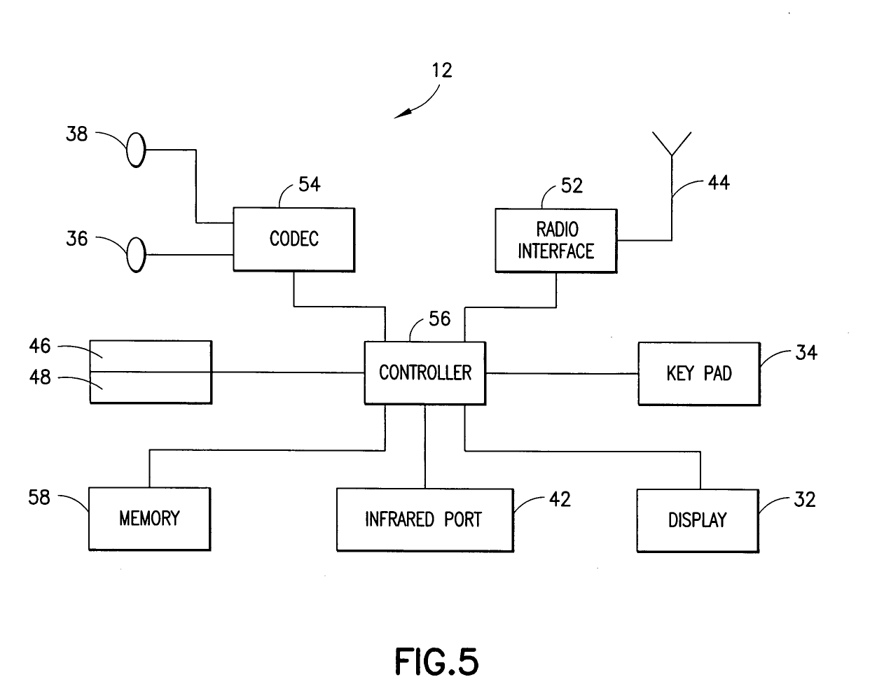

FIGS. 4 and 5 show one representative apparatus or device, such as a mobile phone 12, within which the exemplary embodiments of this invention may be implemented. It should be understood, however, that the exemplary embodiments of this invention are not intended to be limited to one particular type of mobile phone 12 or other electronic device, such as a combination PDA, an integrated messaging device (IMD), a desktop computer, or a notebook computer. The mobile phone 12 of FIGS. 4 and 5 is composed of various components that may include: a housing 30, a display 32, such as one in the form of a liquid crystal display, a keypad 34, a microphone 36, an ear-piece 38, a battery 40, an infrared port 42, an antenna 44, a smart card 46, a card reader 48, radio interface circuit 52, codec circuit 54, a controller 56 and a memory 58. The memory 58 may store a program executable by the controller 56 (e.g., a data processor), and the program may include computer code for at least determining a logical device count for a physical device in an authorized domain; computer code for calculating a sum of the logical device count; and computer code for comparing the sum with a maximum allowable number of devices for the domain. When the mobile phone 12 is a logic device capable of consumption, the memory 58 may also store a consumption rights digital certificate, including the logical device count field discussed in detail above.

In practice, any suitable device connected or coupled to a plurality of devices, either through a cable, a wired bus, or a wireless interface, is enabled to obtain the device count field from the plurality of devices and determine the total number of attached devices, such as the total logical device count of devices in an Authorized Domain, where the device count field of each attached device may indicate a value of one, less than one, and greater than one.

In general, the various embodiments of the device 12 can include, but are not limited to, cellular phones, personal digital assistants (PDAs), portable computers, image capture and/or playback devices, gaming devices, music storage and playback appliances, Internet appliances permitting Internet access and browsing, as well as portable units or terminals that incorporate combinations of such functions.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Based on the foregoing it can be appreciated that in one aspect thereof the exemplary embodiments of this invention provide a method of limiting the size of an Authorized Domain, comprising determining a logical device count for a physical device in the authorized domain; calculating a sum of the logical device count; and comparing the sum with a maximum allowable number of devices for the domain.

The method of the preceding paragraph, wherein the logical device count is a value greater than one when the device is comprised of multiple consumption points. In this case the logical device count equals the number of consumption points for the device.

Further, the logical device count may be a fractional number when a consumption point is comprised of multiple devices. In this case the logical device count may be expressed as a fractional number with numerator as 1 and denominator as the total number of devices needed to render the full content.

In the method the logical device count may be represented by fixed-point binary representation, or it may be is represented by a binary number where at least one bit is used to indicate whether the logical device count is a fractional number.

Based on the foregoing it can be appreciated that in another aspect thereof the exemplary embodiments of this invention provide an electronic device that comprises a processor; and a memory unit communicatively connected to the processor and including computer code for determining a logical device count for a physical device in an authorized domain; computer code for calculating a sum of the logical device count; and computer code for comparing the sum with a maximum allowable number of devices for the domain.

In the device of the preceding paragraph the logical device count may be a value greater than one when the device is composed of multiple consumption points, or the logical device count may be equal to the number of consumption points for the device. The logical device count may be a fractional number when a consumption point is composed of multiple devices. For example, the logical device count may be a fractional number with numerator as 1 and denominator as the total number of devices needed to render the full content. The logical device count may be represented by fixed-point binary representation. The logical device count may be represented by a binary number, where at least one bit is used to indicate whether the logical device count is a fractional number.

Based on the foregoing it can be appreciated that in a further aspect thereof the exemplary embodiments of this invention provide a computer program product, embodied in a computer-readable medium, for limiting the size of an Authorized Domain and comprising computer code for determining a logical device count for a physical device in the authorized domain; computer code for calculating a sum of the logical device count; and computer code for comparing the sum with a maximum allowable number of devices for the domain.

In the foregoing paragraph the logical device count may be a value greater than one when the device is composed of multiple consumption points. The logical device count may equal a number of consumption points for the device. The logical device count may be a fractional number when a consumption point is composed of multiple devices. The logical device count may be represented as a fractional number with numerator as 1 and denominator as the total number of devices needed to render the full content. The logical device count may represented by fixed-point binary representation. The logical device count may be represented by a binary number, where at least one bit is used to indicate whether the logical device count is a fractional number or an integer.

Based on the foregoing it can be appreciated that in yet another aspect thereof the exemplary embodiments of this invention provide an electronic device that includes means for indicating a logical device count for an authorized domain, where the logical device count may be a fractional number.

Based on the foregoing it can be appreciated that in yet another aspect thereof the exemplary embodiments of this invention provide an electronic device that includes means for indicating a logical device count for an authorized domain, where the logical device count may be greater than one.

In the foregoing paragraphs, the means for indicating the logical device count may include any suitable type of storage unit such as, but not limited to, a memory device, a register, or a hard-wired logical element.

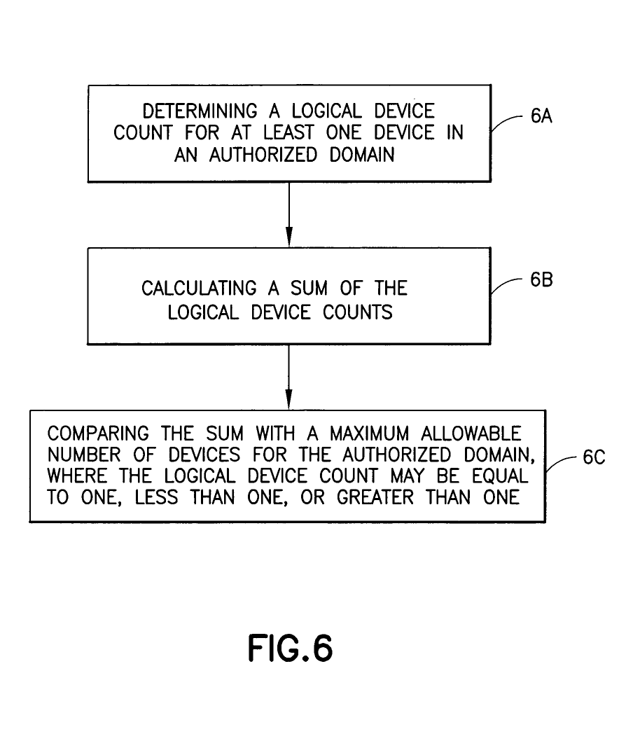

Reference is made to FIG. 6 for illustrating execution of a method, as well as the execution of a computer program, in accordance with the exemplary embodiments of this invention. At Block 6A there is an operation of determining a logical device count for at least one device in an authorized domain; at Block 6B there is an operation of calculating a sum of the logical device counts; and at Block 6C there is an operation of comparing the sum with a maximum allowable number of devices for the authorized domain, where the logical device count for a device may be equal to one, less than one, or greater than one.

The various blocks shown in FIG. 6 may be viewed as method steps, and/or as operations that result from operation of computer program code, and/or as a plurality of coupled logic circuit elements constructed to carry out the associated function(s).

The exemplary embodiments of this invention may thus be described in the general context of method steps, which may be implemented in one embodiment by a program product including computer-executable instructions, such as program code, executed by computers in networked environments. Generally, program modules include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

The foregoing description of exemplary embodiments of the invention have been presented for purposes of illustration and description. The foregoing description is not intended to be exhaustive or to limit the use and/or practice of this invention to the precise form disclosed, and modifications and variations are possible in light of the above teachings or may be acquired from practice of the invention. The exemplary embodiments were chosen and described in order to explain the principles of the invention and its practical application to enable one skilled in the art to utilize the invention in various exemplary embodiments thereof, and with various modifications as are suited to the particular use contemplated.

What is claimed is:

1. A method, comprising:
determining a logical device count for at least one device in an authorized domain;
calculating a sum of the logical device counts; and
comparing the sum with a maximum allowable number of devices for the authorized domain, where the logical device count for a device may be equal to one, less than one, or greater than one.

2. A method as in claim 1, where the logical device count is a value greater than one when a particular device is comprised of multiple consumption points, where a value of the logical device count equals a number of consumption points for the particular device.

3. A method as in claim 1, where the logical device count is a value less than one when a particular consumption point is comprised of multiple devices.

4. A method as in claim 3, where the logical device count is expressed as a fractional number with numerator of one and a denominator equal to the number of devices that are associated with the consumption point.

5. A method as in claim 1, where the logical device count is expressed in a fixed-point binary representation.

6. A method as in claim 1, where the logical device count is expressed as a binary number where at least one bit is used to indicate whether the logical device count represents a fractional number.

7. A method as in claim 6, where the at least one bit is a most significant bit.

8. An apparatus, comprising:
a receiver configurable to receive broadcast content, the receiver associated with a logical device of an authorized domain; and
memory configurable to store a logical device count having a value equal to one, less than one, or greater than one.

9. An apparatus as in claim 8, where the logical device count is a value greater than one when a particular device is comprised of multiple consumption points, where a value of the logical device count equals a number of consumption points for the particular device.

10. An apparatus as in claim 8, where the logical device count is a value less than one when a particular consumption point is comprised of multiple devices.

11. An apparatus as in claim 10, where the logical device count is expressed as a fractional number with numerator of one and a denominator equal to the number of devices that are associated with the consumption point.

12. An apparatus as in claim 8, where the logical device count is expressed in a fixed-point binary representation.

13. An apparatus as in claim 8, where the logical device count is expressed as a binary number where at least one bit is used to indicate whether the logical device count represents a fractional number.

14. An apparatus as in claim 13, where the at least one bit is a most significant bit.

15. A computer readable medium storing program instructions, execution of which result in operations comprising:
determining a logical device count for individual ones of a plurality of devices in an authorized domain;
calculating a sum of the logical device counts; and
comparing the sum with a maximum allowable number of devices for the authorized domain, where the logical device count for a device may be equal to one, less than one, or greater than one.

16. A computer readable medium as in claim 15, where the logical device count is a value greater than one when a particular device is comprised of multiple consumption points, where a value of the logical device count equals a number of consumption points for the particular device.

17. A computer readable medium as in claim 15, where the logical device count is a value less than one when a particular consumption point is comprised of multiple devices.

18. A computer readable medium as in claim 17, where the logical device count is expressed as a fractional number with numerator of one and a denominator equal to the number of devices that are associated with the consumption point.

19. A computer readable medium as in claim 15, where the logical device count is expressed in a fixed-point binary representation.

20. A computer readable medium as in claim 15, where the logical device count is expressed as a binary number where at least one bit is used to indicate whether the logical device count represents a fractional number.

21. A computer readable medium as in claim 15, where the at least one bit is a most significant bit.

22. An apparatus, comprising:
a receiver configurable to receive content and coupled with a logical device of an authorized domain; and
a storage unit configurable to store a logical device count having a value equal to one, less than one, or greater than one.

23. An apparatus as in claim 22, where the logical device count has a value greater than one when a particular device is comprised of multiple consumption points, where a value of the logical device count equals a number of consumption points for the particular device, and where the logical device count has a value less than one when a particular consumption point is comprised of multiple devices.

24. An apparatus as in claim 22, where when the logical device count has a value less than one the logical device count is expressed as a fractional number with numerator of one and a denominator equal to the number of devices that are associated with the consumption point.

25. An apparatus as in claim 22, where the logical device count is expressed as a binary number where at least one bit is used to indicate whether the logical device count represents a fractional number.
